(19) United States
(12) Patent Application Publication
(10) Pub. No.: US 2022/0096883 A1
(43) Pub. Date: Mar. 31, 2022

(54) VSTOL Firefighting System

(71) Applicant: Erik Thomas Robinson, Telluride, CO (US)

(72) Inventor: Erik Thomas Robinson, Telluride, CO (US)

(21) Appl. No.: 17/035,980

(22) Filed: Sep. 29, 2020

(51) Int. Cl. A62C 3/02; B64D 1/16

(52) U.S. Cl. CPC A62C 3/0242; B64D 1/16

(57) ABSTRACT

This invention is for use in the firefighting industry and is of interest to manufacturers of firefighting machinery and vehicles. Potential users include fire departments and rescue services of all levels, from municipal fire departments up to and including the U.S. Park Service and U.S. Coast Guard.

It is a firefighting system designed for non-permanent installation onto an V-22 Osprey aircraft for use in supporting fire department operations.

An ideal embodiment of this invention is a system of eight components including a holding tank and pumping system held inside of the aircraft cargo area, and a frame with a turret with adjustable arm and nozzle mounted over top of the cockpit on the exterior of the aircraft.

### CROSS REFERENCE TO RELATED APPLICATIONS

(NOT APPLICABLE)

### STATEMENT REGARDING FEDERALLY SPONSORED RESEARCH OR DEVELOPMENT

(NOT APPLICABLE)

### REFERENCE TO SEQUENCE LISTING, A TABLE, ORA COMPUTER PROGRAM LISTING COMPACT DISC APPENDIX

(NOT APPLICABLE)

### BACKGROUND OF THE INVENTION

This invention is a system to provide fire suppression from the air using a V-22 Osprey aircraft. The Osprey is an aircraft manufactured as a joint venture of the aircraft manufacturing firms of Boeing and Bell-Textron. It is a V/STOL aircraft, which means vertical/short takeoff and landing. By rotating its engine nacelles it can takeoff, fly and land like an airplane, but in a shorter than normal distance, and can also take-off, fly, hover and land like a helicopter.

The first proposed area for use is fires on tall buildings or other structures. Other potential uses include: delivering fire suppression to fires on roadways stalled with traffic; fires in remote areas; forest fires and maritime fires such as those on ships, docks, harbors and offshore oil production structures.

There are a variety of vehicles for firefighting. On land there are various types of fire trucks, the largest models having ladder, boom or snorkel systems, some of which can extend well over 100 feet/30.48 meters and from there are able to project water in excess of 100 feet/30.48 meters. Their on-board water tanks can be augmented by fire hydrant systems to maintain fire suppression. On water, there are fireboats and some tugboats which have water cannons which can give an infinite supply of fire suppression as far as 100 feet/30.48 meters. These are not fast vessels and not used on open seas, generally being used in harbors for fires on ships, smaller watercraft and piers.

In the realm of firefighting aircraft there are airplanes, which can drop large quantities of water, but in a relatively inaccurate strafing pattern generally reserved for forest fires. There are also helicopters, which use various types of buckets to drop water directly onto a fire with great accuracy, but without great capacity.

There is currently no one vehicle on ground, on water or in the air that combines the amount of fire suppression with the speed of arrival on scene, range of altitude of use and accuracy of delivery proposed with this invention.

### BRIEF SUMMARY OF INVENTION

An Osprey aircraft equipped with some embodiment of the proposed invention would be capable of providing a large amount of fire suppression, equal to that of many fire trucks, at the heights required in firefighting on tall buildings, and also be able to quickly get to fires on roadways jammed with traffic, or in remote areas, forests and on water.

### BRIEF DESCRIPTION OF THE SEVERAL VIEWS OF THE DRAWING

FIG. 1 displays a Port/Left Side view of an aircraft equipped with a preferred embodiment of the invention.

FIG. 2 displays a Top view of an aircraft equipped with a preferred embodiment of the invention.

### DETAILED DESCRIPTION OF THE INVENTION

The system is made up of two sets of components. Inside the aircraft's cargo bay is a pumping system with holding tank. Strapped to the top of the aircraft is a frame supporting a turret over top of the cockpit. This turret has an adjustable arm with a nozzle assembly on the end. The whole system with its accessories and full tank does not exceed the aircraft's weight load limits and the pump/tank unit fits within the confines of the cargo area. The system runs off of the electrical current provided by the aircraft and can be supplied with a battery pack or generator. It is operated from the cockpit and supported by other crew members in the cargo bay.

A preferred embodiment is designed to work with the Osprey aircraft currently in production. According to publicly available information, the current cargo space area in the Osprey is 20.75 feet/6.32 meters long by 5.67 feet/1.72 meters wide by 6.5 feet/1.98 meters high and the weight limit is 20,000 pounds/9072 kilograms. These dimensions and weight limits are subject to change as the aircraft evolves. Preliminary calculations based on existing stand-alone firefighting systems indicate that the entire system, with at least a 1000 gallon/3785 liter load of water and/or other firefighting medium weighing 8330 pounds/3778 kilograms and occupying approximately 134 cubic feet/3.79 cubic meters, can be made to meet these space and weight limitations. This is especially feasible if lightweight materials are utilized wherever possible.
There are 8 main components to a preferred embodiment:

### 1) Pump/tank Unit

The first part to a preferred embodiment of the invention consists of a holding tank with pumping engine, controls, and hookup points for hoses, electrical power and control cables. The whole assembly is mounted on wheels and held inside of the cargo section of the aircraft, just behind the side entry door.

The holding tank is ideally capable of holding at least 1000 gallons/3785 liters of water and or other fire fighting medium and the pumping system shall achieve flow rates of at least 1000 gallons/3785 liters per minute and generate nozzle discharge pressures of over 100 pounds/45.36 kilograms per square inch. The tank ideally has baffles installed in its interior, from front to back and left to right, with sufficient openings on top for air and on bottom for liquids. This is to prevent massive shifts of liquid in flight, preventing loss of balance and stability. Another design feature to aid in balance and stability is that the tank is mounted as low as possible to lower its center of gravity.

The controls on the Pump/tank unit include, at a minimum, all controls needed to turn the system on and off, switch between filling, emptying and discharge functions, adjust the flow rate and a manual override taking control from the Control Panel (8) as needed. There will also be necessary gauges and indicators for information such as the water level and discharge pressure.

The holding tank is filled or emptied, on the ground or in the air, by a series of flexible and rigid hoses extended from the cargo loading door in the rear of the aircraft and/or the crew door on the right hand/starboard side of the aircraft. If filling from a lake, ocean, pond or other unfiltered source, a filter basket can be utilized to prevent debris from clogging the system. These hoses and filter baskets are readily available items in the fire fighting industry, likely requiring no modification for use with this invention.

Another part to the Pump/tank unit is the power supply for the whole system. This consists of power from the aircraft's onboard power system, but may also be replaced or augmented by a battery pack and or generator. As with any device used for the military or emergency services, it is highly recommended that a preferred embodiment of the invention have a backup power supply.

The Pump/tank unit, generator/battery pack and hoses are capable of being flown to a location and unloaded to act as a stand-alone firefighting system for firefighters.

### 2) Turret Lines

A second component to a preferred embodiment of this invention are the Turret Lines going to the Turret (5) for water, power and controls, which ideally are bundled together in a removable covering. Ideally they run from the Pump/tank Unit (1), through the Access Port (3), through the Turret Frame (4) to attachment points on Turret (5). Ideally, the removable covering and each of the individual lines are fire and water resistant.

### 3) Access Port

The third component of a preferred embodiment is an Access Port. It is a hole for the Turret Lines (2) which is located at the rear of the top/dorsal side of the Osprey or other aircraft, behind the area which pivots the wings for storage. Ideally there is a covering fabricated fill the port so the aircraft can operate when the system is not installed. Based on the width of existing fire hoses, this port is at least 6 inches/15.24 centimeters wide. It is useful to note that the installing of this port onto the aircraft is the only permanent modification needed for the aircraft.

### 4) Turret Frame

A fourth component of a preferred embodiment, the Turret Frame, consists of a rigid frame with padding as needed to protect the aircraft from vibration and abrasion. Ideally the frame extends from close to the Access Port (3) along the dorsal side, to over top of the cockpit. Ideally it is held on by straps running under the belly of the aircraft, from in front of and to the rear of the wings. These straps must not interfere with using the door on the right/starboard side of the fuselage. Ideally the frame has a covered channel to hold and protect the Turret Lines (2). Ideally the Turret Frame also has attachment hooks or other type of link to easily facilitate installation and removal. Fireproof and waterproof materials must be used throughout this component.

### 5) Turret

The fifth component of a preferred embodiment of the invention is the Turret which holds the Adjustable Arm (6) with the Nozzle Head (7). It is ideally situated over the top of the cockpit. Ideally it uses servo motors to transverse the Turret from left to right and to lift and lower the Adjustable Arm (6). It has connections for the Turret Lines (2). The range of motion for Turret and Arm must prevent the Adjustable Arm (6) and the discharge from Nozzle Head (7) from coming into contact with the aircraft's rotors and nose of the aircraft. Another possible part is a camera to assist the operator at the Control Panel (8) with aiming. Fireproof and waterproof materials must be used throughout this component.

### 6) Adjustable Arm

A sixth component of a preferred embodiment, the Adjustable Arm contains the lines for the water, power and controls. On the end of the arm is the Nozzle Head (7). It ideally has servo motors to extend and retract the telescoping sections. Another suggested part to this component is a support bracket mounted on the nose of the aircraft to provide a safe holding area during flight and on the ground. Ideally there are sensors on the Arm and bracket to communicate with the Control Panel (8) when the arm is set in place. Fireproof and waterproof materials must be used throughout this component.

### 7) Nozzle Head

A seventh component of a preferred embodiment, the Nozzle Head ideally has servo motors to allow fullest articulation around the the Adjustable Arm (6) and to adjust the flow type on the Nozzle itself from spray to stream. Ideally it has a series of lights to assist in aiming, including lights to indicate to the user the position and direction of the Nozzle Head, a laser designating device and a spotlight. It may also have a camera to assist the controller in aiming. Fireproof and waterproof materials must be used throughout this component.

### 8) Control Panel

The eighth component of a preferred embodiment is the control panel. It is ideally situated inside the cockpit of the aircraft, most likely in the lap of a pilot or other member of the crew. It must be waterproof and impact proof. Communications with the system are sent via a control cable running to the Pump/tank unit (1). Ideally the Control Panel is capable of performing the functions of: turning the Pump/tank Unit (1) on and off, aiming and firing the nozzle, adjusting the type of discharge from spray to stream and discharge pressure. Ideally it also has a video screen with which to allow video feed from the camera(s) utilized for aiming. It is powered by the onboard electricity and/or a rechargeable battery pack.

### DETAILED DESCRIPTION OF THE DRAWINGS

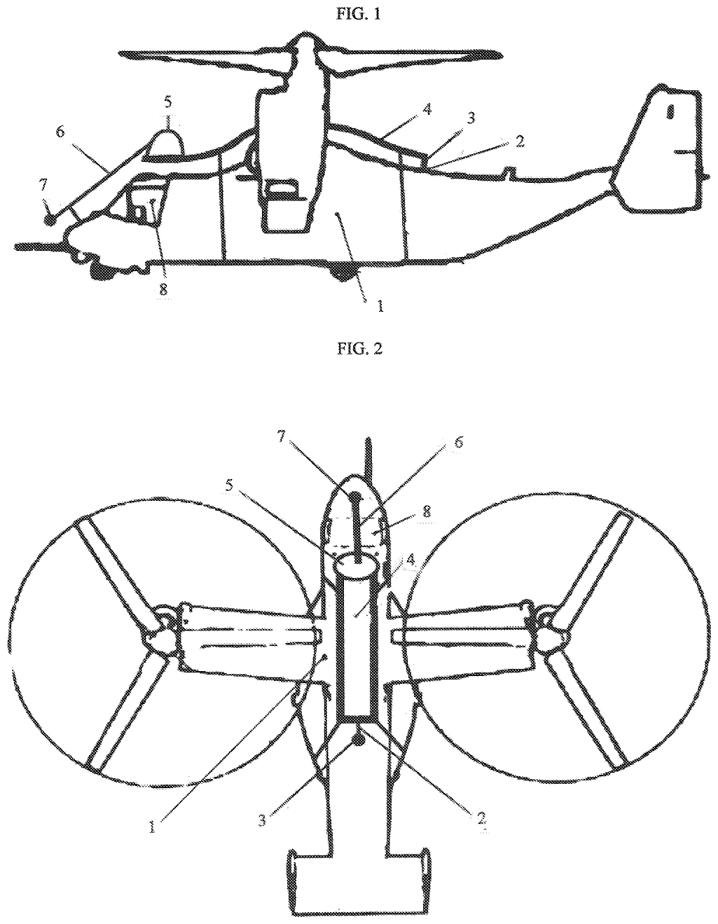

Referring to FIGS. 1 and 2 of the Diagram, a Pump/tank unit 1 is depicted by pointing out the likely position inside the aircraft. The Pump/tank unit 1 is equipped with the holding tank as well as connections for water or other firefighting medium, power and electronic command lines. The Turret Lines 2 connect the Pump/tank Unit 1 through the Access Port 3 along the Turret Frame 4 to their connection points on the Turret 5. The Access Port 3 allows the transit of Turret Lines 2. The Turret Frame 4 holds the Turret Lines 2 running to the Turret 5 and supports the Turret 5 on the aircraft. The Turret 5 at the front of the aircraft holds and moves the Adjustable Arm 6 which in turn holds and moves the Nozzle Head 7. The entire system is controlled by the Control Panel 8 which communicates with the Pump/tank unit 1.

1. A firefighting system for non-permanent installation onto an aircraft, the preferred embodiment of which is comprised of:
a Pump/tank Unit consisting of a holding tank with pumping engine, controls and connections for Control Panel, Turret Lines and held inside of the cargo bay of the aircraft;
a series of Turret Lines carrying water, power and commands in a removable covering connecting the Pump/tank Unit and the Turret;
an Access Port on top of the aircraft allowing passage of the Turret Lines from the Pump/tank Unit in the aircraft's interior to the Turret Frame on the exterior of the aircraft;
a Turret Frame on top of the aircraft consisting of a padded rigid frame with a covered channel or conduit for the Turret Lines and held on by straps in the front of and to the rear of the wing;
a Turret located above the cockpit on the Turret Frame, holding and maneuvering the Adjustable Arm;
an Adjustable Arm which holds the Nozzle Head and water/power/control lines for it and may also include a holding bracket mounted on the nose of the aircraft;
a Nozzle Head attached to the end of the Adjustable Arm; and
a Control Panel allowing operator to control system from the cockpit.

2. A firefighting system as stated in claim 1, wherein the Turret Frame is held on by hard points* installed onto the dorsal side of the aircraft, in addition to or in place of straps that run underneath of the belly of the craft. *- A hard point, as it pertains to aviation, is a term used to describe attachment points permanently installed onto the body and frame of an aircraft, generally military. These hard points are generally used for carrying accessories such as fuel tanks, cargo pods and weapons.

3. A firefighting system as stated in claim 1, wherein the Control Panel uses a cordless/wireless system for transmitting commands instead of a cable.

4. A firefighting system as stated in claim 1, wherein the telescoping sections of the Adjustable Arm is coupled with or replaced by one or more folding sections.
